(19) United States
(12) Patent Application Publication
(10) Pub. No.: US 2021/0204527 A1
(43) Pub. Date: Jul. 8, 2021

(54) MODULAR FLOATATION COLLAR FOR AQUACULTURE APPLICATIONS

(71) Applicant: Poseidon Ocean Systems Ltd., Campbell River (CA)

(72) Inventors: Mathew Stephen CLARKE, Campbell River (CA); Jeffrey FLEMING, Campbell River (CA)

(73) Assignee: Poseidon Ocean Systems Ltd., Campbell River (CA)

(21) Appl. No.: 17/208,660

(22) Filed: Mar. 22, 2021

Related U.S. Application Data
(63) Continuation of application No. PCT/CA2019/051367, filed on Sep. 24, 2019.
(60) Provisional application No. 62/735,832, filed on Sep. 24, 2018.

(51) Int. Cl. A01K 61/65; B63B 35/44

(52) U.S. Cl. CPC A01K 61/65; B63B 2035/4426; B63B 35/44

(57) ABSTRACT

A segment for a modular floatation collar comprises a frame having a recessed compartment and a removable decking covering the recessed compartment. The frame is mounted on a floatation unit. There are a plurality of rigging hardpoints and a plurality of installation hardpoints disposed along the frame. A universal connection at each end of the frame allows the segment to be connected to an adjacent segment either linearly along a common axis or orthogonally at a right angle. The floatation unit extends between adjacent segments in the floatation collar.

### BACKGROUND

### Technical Field

The present disclosure relates to a floatation collar for aquaculture applications and, in particular, to a modular floatation collar for aquaculture applications.

### Description of the Related Art

U.S. Pat. No. 4,886,015 which issued on Dec. 12, 1989, to Ochs discloses a modular marine floatation collar for aquaculture applications. Component collar segments are sealed by bulkheads including a connecting flange. Standard component collar segments may be assembled into a desired configuration by flange-to-flange connection of adjacent collar segments. A plurality of elongate tubular members having arcuate recesses conforming to the outer perimeters of supporting collar segments are arranged transversely atop the collar assembly so as to provide for the construction of an elevated walkway.

### SUMMARY OF THE DISCLOSURE

It is an object of the present disclosure to provide an improved modular floatation collar for aquaculture applications.

There is accordingly provided a segment for a modular floatation collar. The segment comprises a frame having a recessed compartment and a removable decking covering the recessed compartment. There is a plurality of rigging hardpoints disposed along the frame. A universal connection at each end of the frame allows the segment to be connected to an adjacent segment either linearly along a common axis, or orthogonally at a right angle. The rigging hardpoints may be disposed along a centerline of the frame. The segment may further include a plurality of installation hardpoints disposed along the frame. The frame may be mounted on a floatation unit. The floatation unit may be a plurality of spaced-apart, parallel lengths of pipe.

There is also provided a modular floatation collar comprising a segment including a frame having a recessed compartment and a removable decking covering the recessed compartment. There is a plurality of rigging hardpoints disposed along the frame. A universal connection at each end of the frame allows the segment to be connected to an adjacent segment either linearly along a common axis, or orthogonally at a right angle. The rigging hardpoints may be disposed along a centerline of the frame. The segment may further include a plurality of installation hardpoints disposed along the frame. The frame may be mounted on a floatation unit. The floatation unit is a plurality of spaced-apart, parallel lengths of pipe.

There is further provided a modular floatation collar comprising a first segment and a second segment. The first segment of the modular floatation collar has a frame and decking mounted on the frame. The second segment of the modular floatation collar has a frame and decking mounted on the frame. The modular floatation collar also includes a floatation unit. The first segment of the modular floatation collar and the second segment of the modular floatation collar are each mounted on the floatation unit. The floatation unit extends between the first segment of the modular floatation collar and the second segment of the modular floatation collar. The floatation unit may be a plurality of spaced-apart, parallel lengths of pipe. The first segment of the modular floatation collar is connected to the second segment of the modular floatation collar linearly along a common axis. The first segment of the modular floatation collar is connected to the second segment of the modular floatation collar orthogonally at a right angle.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of a modular floatation collar for aquaculture applications;

FIG. 2 is a fragmentary, perspective view of a segment of the modular floatation collar;

FIG. 3 is a fragmentary, perspective view of an end of the segment of the modular floatation collar;

FIG. 4 is a perspective view of a first segment of the modular floatation collar connected to a second segment of the modular floatation collar; and

FIG. 5 is another perspective view of the first segment of the modular floatation collar connected to the second segment of modular floatation collar.

### DESCRIPTION OF THE SPECIFIC EMBODIMENTS

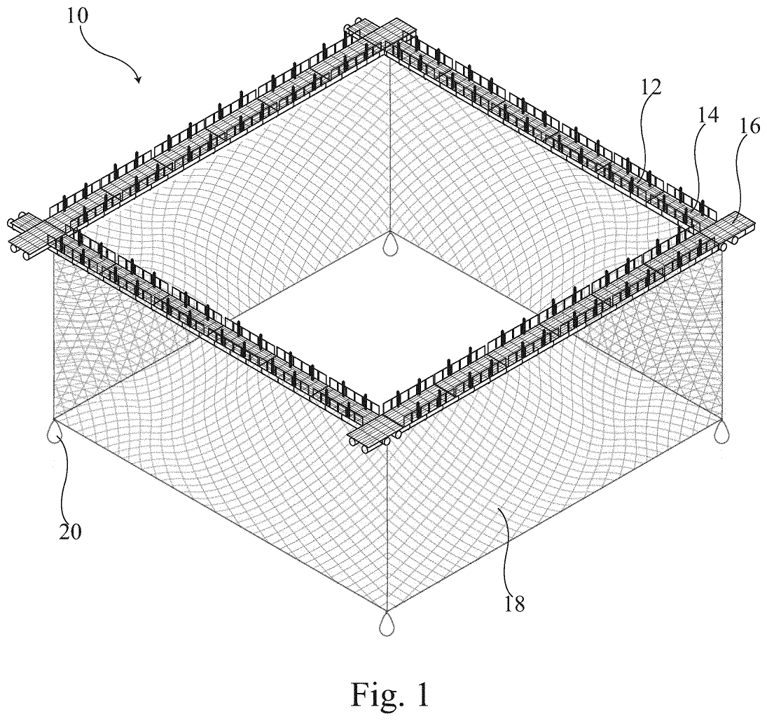

Referring to the drawings and first to FIG. 1, a modular floatation collar 10 is shown. The floatation collar 10 may be used in aquaculture applications, for example, as part of an aquaculture pen system. The floatation collar 10 comprises a plurality of segments, for example, a first segment 12, a second segment 14, and a third segment 16. The segments are each configured to be coupled to an adjacent segment either linearly along a common axis, as shown for the first segment 12 and the second segment 14, or orthogonally at a right angle, as shown for the second segment 14 and the third segment 16. This allows for the construction of a floatation collars of various sizes and configurations. In this example, the floatation collar is coupled to a net 18 with weights, for example weight 20, as part of an aquaculture pen system.

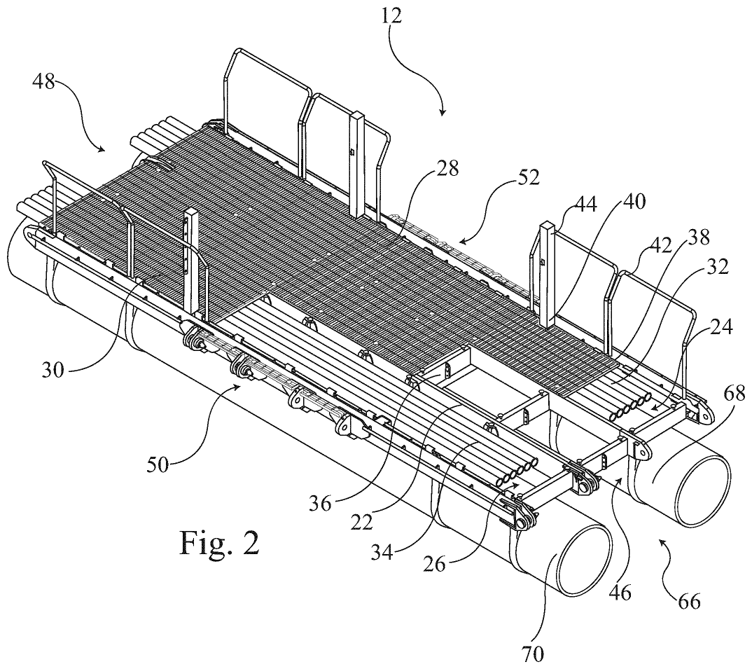

The segments are substantially the same in structure and function. Accordingly, only the first segment 12 is described in detail herein with the understanding that the other segments have substantially the same structure and function in substantially the same manner. The first segment 12 is shown in greater detail in FIG. 2. The first segment 12 is generally includes a frame 22 which has a plurality of recessed compartments 24 and 26 which are covered by corresponding decking 28 and 30 mounted on the frame. The recessed compartments 24 and 26 allow for piping 32 and 34 as well as other equipment to be disposed in a work-safe and continuous manner to meet various aquaculture pen system configurations and equipment needs. The decking 28 and 30 is removable, and preferably lightweight, to allow access to the recessed compartments 24 and 26. This allows for easier cleaning and maintenance of the modular floatation collar 10 in the field.

There are rigging hardpoints disposed along a centerline of the first segment 12, for example rigging hard point 36, which allow for weight directed deployment of a net (not shown) and adjustment of the net from the surface. The rigging hardpoints disposed along a centerline of the first segment 12 allow for internal centerline rigging to provide a more stable aquaculture pen system under a variety of loading conditions. The rigging hardpoints along a centerline of the first segment 12 also allow access for easier cleaning and maintenance of the net in the field. There are hardpoints disposed along a longitudinal edge of the segment, for example hardpoint 38 and hardpoint 40, which allow for the installation of rigging, supports, and other accessories. For example, a railing 42 is installed at hardpoint 38 and a support post 44 is installed at hardpoint 40. This mitigates against jury-rigged installations.

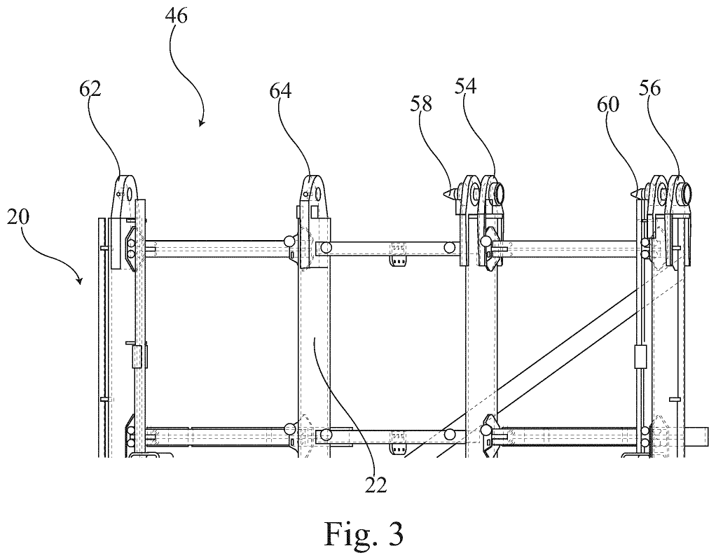

Each end of the first segment 12 is provided with a respective one of universal connectors 46 and 48. Each side of the first segment 12 is also provided with a respective one of the universal connectors 50 and 52. The universal connectors 46, 48, 50 and 52 are substantially the same in structure and function. Accordingly, only one of the universal connectors 46 is described in detail herein with the understanding that the other ones of the universal connectors 48, 50 and 52 have substantially the same structure and function in substantially the same manner. The universal connector 46 is shown in greater detail in FIG. 3. The universal connector 46, in this example, includes a pair of clevises 54 and 56, together with corresponding pins 58 and 60, and a pair of tangs 62 and 64. The clevises 54 and 56 are received by corresponding tangs at an end of an adjacent segment when the segments are connected linearly along a common axis. The tangs 62 and 64 are received by corresponding clevises at an end of an adjacent segment when the segments are connected linearly along a common axis. The clevises 54 and 56 are received by corresponding tangs at a side of an adjacent segment when the segments are connected orthogonally at a right angle. The tangs 62 and 64 are received by corresponding devises at a side of an adjacent segment when the segments are connected orthogonally at a right angle.

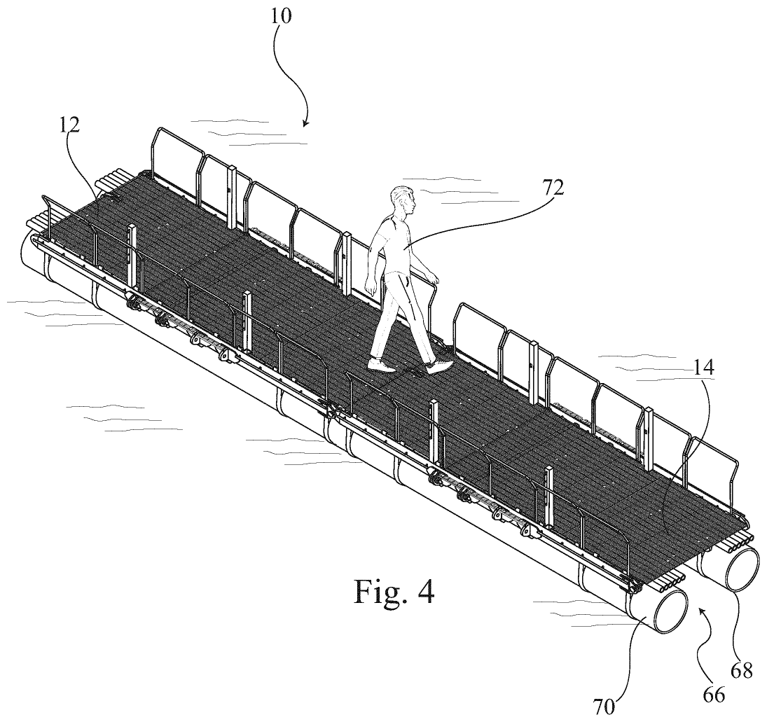

Referring back to FIG. 2, the first segment 12 mounted on a continuous floatation unit 66 which, in this example, is a pair of spaced-apart, parallel lengths of pipe 68 and 70 which extend between adjacent segments. The lengths of pipe 68 and 70 may be high density polyethylene (HDPE) pipe, medium density polyethylene (MDPE) pipe, or pipe formed of any other suitable material with rigid and flexible properties. Referring now to FIG. 4, as shown for the first segment 12 and the second segment 14, the segments are each mounted on the continuous floatation unit 66 and the continuous floatation unit 66 extends between adjacent ones of the segments. The continuous floatation unit 66 is sufficiently rigid that it will support the weight of a person 72, without flexing, when the person 72 walks along the floatation collar 10. This restricts the segments from becoming offset when the person 72 steps from a segment to an adjacent segment.

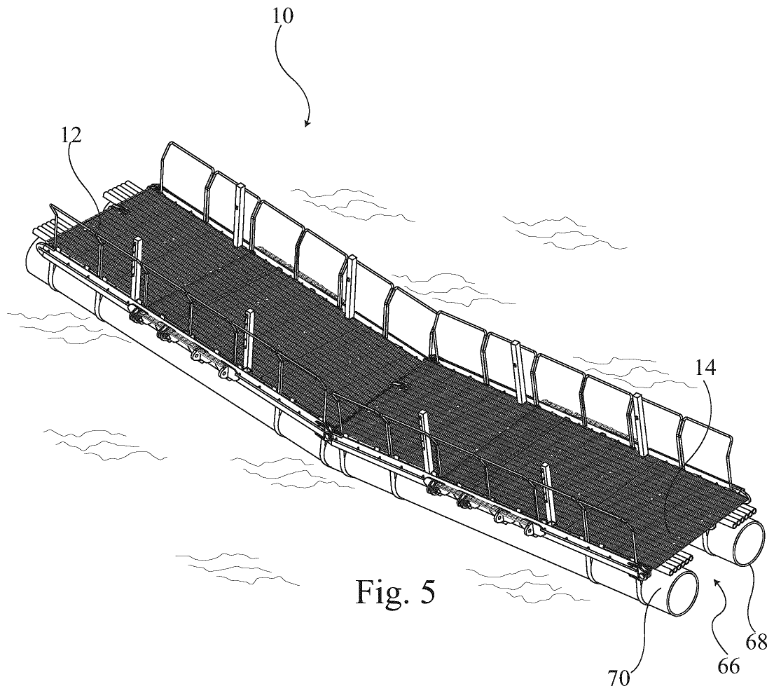

However, the continuous floatation unit 66 may also flex under heavy loads as shown in FIG. 5. The continuous floatation unit 66 thereby decreases the amplitude of impact from wave action and dampen the movement across connections between adjacent segments. The continuous floatation unit 66 also secure an edge-free barrier to the net and other components such as weighting.

### ADDITIONAL DESCRIPTION

Examples of modular floatation collars have been described. The following clauses are offered as further description.
(1) A segment for a modular floatation collar, the segment comprising: a frame having a recessed compartment; a removable decking covering the recessed compartment; a plurality of rigging hardpoints disposed along the frame; and a universal connection at each end of the frame to allow the segment to be connected to an adjacent segment either linearly along a common axis or orthogonally at a right angle.
(2) The segment of clause 1 wherein the rigging hardpoints are disposed along a centerline of the frame.
(3) The segment of clause 1 further including a plurality of installation hardpoints disposed along the frame.
(4) The segment of clause 1 wherein the frame is mounted on a floatation unit.
(5) The segment of clause 4 wherein the floatation unit is a plurality of spaced-apart, parallel lengths of pipe.
(6) A modular floatation collar comprising a segment as claimed in any one of clauses 1 to 5.
(7) A modular floatation collar comprising: a first segment of the modular floatation collar having a frame and decking mounted on the frame; a second segment of the modular floatation collar having a frame and decking mounted on the frame; and a floatation unit, wherein the first segment of the modular floatation collar and the second segment of the modular floatation collar are both mounted on the floatation unit, and the floatation unit extends between the first segment of the modular floatation collar and the second segment of the modular floatation collar.\
(8) The modular floatation collar of clause 7 is a plurality of spaced-apart, parallel lengths of pipe.
(9) The modular floatation collar of clause 7 or 8 wherein the first segment of the modular floatation collar is connected to the second segment of the modular floatation collar linearly along a common axis.
(10) The modular floatation collar of clause 7 or 8 wherein the first segment of the modular floatation collar is connected to the second segment of the modular floatation collar orthogonally at a right angle.

It will also be understood by a person skilled in the art that many of the details provided above are by way of example only, and are not intended to limit the scope of the invention which is to be determined with reference to the following claims.

What is claimed is:

1. A modular floatation collar comprising:
a first segment including a frame and decking mounted on the frame thereof;
a second segment including a frame and decking mounted on the frame thereof;
a pivotal connection between said segments; and
a floatation unit, wherein the first segment and the second segment are both mounted on the floatation unit, and the floatation unit extends between the first segment and the second segment.

2. The modular floatation collar as claimed in claim 1, wherein each said frame has a recessed compartment and wherein each said segment includes a removable decking covering the recessed compartment thereof.

3. The modular floatation collar as claimed in claim 1, wherein each said frame includes a plurality of rigging hard points, the rigging hardpoints being disposed along a centerline of the frame.

4. The modular floatation collar as claimed in claim 1 wherein the first segment is connected to the second segment linearly along a common axis.

5. The modular floatation collar as claimed in claim 1 wherein the first segment is connected to the second segment orthogonally at a right angle.

6. The modular floatation collar as claimed in claim 1 wherein the floatation unit has flexible properties.

7. The modular floatation collar as claimed in claim 1 wherein the floatation unit has flexible and rigid properties.

8. The modular floatation collar as claimed in claim 1, wherein the floatation unit comprises-one or more parallel lengths of pipe.

9. The modular floatation collar as claimed in claim 8, wherein the pipe is made of high density polyethylene (HDPE) pipe, medium density polyethylene (MDPE) pipe, or any other suitable material with rigid and flexible properties.

10. The modular floatation collar as claimed in claim 1, further including one or more universal connectors via which the segments connect, the one or more universal connectors comprising one or more hinged said connections.

11. The modular floatation collar as claimed in claim 1, further including one or more universal connectors via which the segments are connectable, wherein at least one end of each said segment is provided with a respective one of the universal connectors, and wherein at least one side of each said segment is provided with a respective one of the universal connectors.

12. The modular floatation collar as claimed in claim 1, further including one or more universal connectors via which the segments are connectable, each said universal connector comprising at least one clevis coupled to a first of the segments, at least one tang coupled to a second of the segments, and a corresponding pin which extends through said at least one clevis and said at least one tang.

13. The modular floatation collar as claimed in claim 1, wherein the first segment is connectable to the second segment linearly along a common axis or orthogonally at a right angle.

14. The modular floatation collar as claimed in claim 1, wherein the pivotal connection comprises a universal said connection at each end of each said frame which allows each said segment to be connected to an adjacent said segment either linearly along a common axis or orthogonally at a right angle.

15. The modulator floatation collar as claimed in claim 1, wherein the pivotal connection couples said segments around a horizontal pivoting axis.

16. An aquaculture pen system comprising a modular floatation collar as claimed in claim 1.

17. A segment for a modular floatation collar, the segment comprising:
a frame having a pair of spaced-apart sides and a pair of spaced-apart ends extending between the sides thereof; and
universal connectors coupled to at least one said end and at least one said side of the frame, each said universal connector including at least one clevis, a corresponding pin, and at least one tang spaced-apart from the at least one clevis thereof;
wherein the at least one clevis at one said end of the segment is connectable via a first said pin to a corresponding said tang of an adjacent said segment at an end of the adjacent said segment and wherein the at least one tang at the one said end of the segment is connectable via a second said pin to a corresponding said clevis of the adjacent said segment at the end of the adjacent said segment when the segments are connected linearly along a common axis; and
wherein the at least one clevis at the one said side of the segment is connectable via the first said pin to the corresponding said tang of the adjacent said segment at the end of the adjacent said segment and wherein the at least one tang at the one said side of the segment is connectable via the second said pin to the corresponding said clevis of the adjacent said segment at the end of the adjacent said segment when the segments are connected orthogonally at a right angle.

18. A modular floatation collar comprising:
a two or more segments pivotally coupled together, each said segment having a frame and decking mounted on the frame thereof; and
a floatation unit to which the two or more segments are mounted, the floatation unit extending between the two or more segments and dampening movement between the two or more segments.

19. The modular floatation collar as claimed in claim 18, wherein the floatation unit has rigid and flexible properties.

20. The modular floatation collar as claimed in claim 18, wherein the floatation unit comprises one or more parallel lengths of pipe.
